(19) United States
(12) Patent Application Publication
(10) Pub. No.: US 2006/0277822 A1
(43) Pub. Date: Dec. 14, 2006

(54) Process to realise a soil block

(76) Inventor: Marc Varlet, etel (FR)

Correspondence Address: Gerald E. Helget;Briggs and Morgan, 80 South Eight Street, Suite 2200, Minneapolis, MN, 55402, US

(21) Appl. No.: 10/576,592

(22) PCT Filed: Oct. 14, 2004
(86) PCT No.: PCT/FR04/02630

§ 371 Date: Apr. 19, 2006

(30) Foreign Application Priority Data
Oct. 20, 2003 (FR) 0312254

(51) Int. Cl. A01G 9/08

(52) U.S. Cl. 47/1.01 R; 264/319

(57) ABSTRACT

The invention concerns a method of producing a mound of earth (21) on the ground (22), comprising:

a step of filling a mould (1) with earth;

a step of placing a cover plate on the mould (1);

a step of turning over the mould (1) on the ground (22); a step of removing the cover plate;
a method during which a recess (24) is produced at the top of the mound (21) by the mould (1) during the moulding of the mound (21) by the mould (1) and characterised in that it comprises a step of partial removal of the mould (1) so as to leave clear access to the recess (24).

The invention concerns a method of producing a mound of earth on the ground, and a method of planting a plantlet and its clod in such a mound of earth. This invention also concerns a mould for producing such a mound of earth and protective covering for the said mound of earth. It finds an application in the field of cultivation, such as strawberry plants.

A method of planting plantlets is already known in which the gardener produces a hump and then a recess at the top of this hump in order to insert a plantlet and its clod therein. This method raises the plant and leaves clear the fruit that hang under the leaves of the plant, which increases the sunshine and facilitates picking.

This method is constraining because the hump is produced manually and requires moving a great deal of earth, which is tiring for the gardener, and because producing the recess may damage the hump, requiring its reconstruction.

One solution is afforded by the document GB-A-775,174 which describes the production of a mound of earth with a recess at the top using a mould. The mounds thus produced are of a small size, and in particular it is impossible to produce larger mounds because the earth will escape from the mould during turning over.

An object of the present invention is to propose a method of producing a mound of earth with a recess which does not have the drawbacks of the prior art.

To this end a method of producing a mound of earth on the ground is proposed, comprising:
a step of filling a mould with earth;
a step of placing a cover plate on the mould;
a step of turning over the mould on the ground;
a step of removing the cover plate;
   a method during which a recess is produced at the top of the mound by the mould during the moulding of the mound by the mould and which comprises a step of partial removal of the mould so as to leave clear access to the recess.

The invention also proposes a method of producing a mound of earth on the ground comprising:
a step of filling a mould with earth;
a step of placing a cover plate on the mould;
a step of turning over the mould on the ground;
a step of removing the cover plate;
a step of removing the mould;
   a method during which a recess is produced at the top of the mound by the mould during the moulding of the mound by the mould and such that the step of removing the mould is followed by a step of placing a protective mound cover covering the mound.

Advantageously, the recess is a semi-ellipsoid.

The invention also proposes a method of planting a plantlet and its clod, comprising:
a step of producing a mound of earth according to one of the above methods of producing a mound of earth;
a step of placing the plantlet and its clod in the recess in the mound through an opening in the mound cover;
   so that the mound and the recess have complementary shapes.

The invention also proposes a mould adapted to producing a mound according to one of the above methods of producing a mound of earth and comprising:
a truncated cone forming the lateral walls of the mould;
a surface at the centre of the mould;
a connecting surface forming the bottom of the mould between the truncated cone and the surface extending from the connecting surface towards the inside of the truncated cone in order to produce the recess at the top of the mound; and
a covering plate for the mould;
   the mould being such that the surface is a semi-ellipsoid.

Advantageously, the surface is removable.

Advantageously, the connecting surface descends from the truncated cone towards the surface.

Advantageously, the connecting surface is a truncated cone.

The invention also proposes a protective mound cover for a mound of earth produced according to one of the above methods of producing a mound of earth and comprising:
a truncated cone forming the lateral walls of the mound cover;
a top surface forming the top of the mound cover;
   the mound cover being such that the top surface is provided with an access opening to the recess.

Advantageously, the top surface descends from the truncated cone towards the opening.

Advantageously, the top surface is a truncated cone.

The characteristics of the invention mentioned above, as well as others, will emerge more clearly from a reading of the following description of an example embodiment, the said description being given in relation to the accompanying drawings, amongst which:

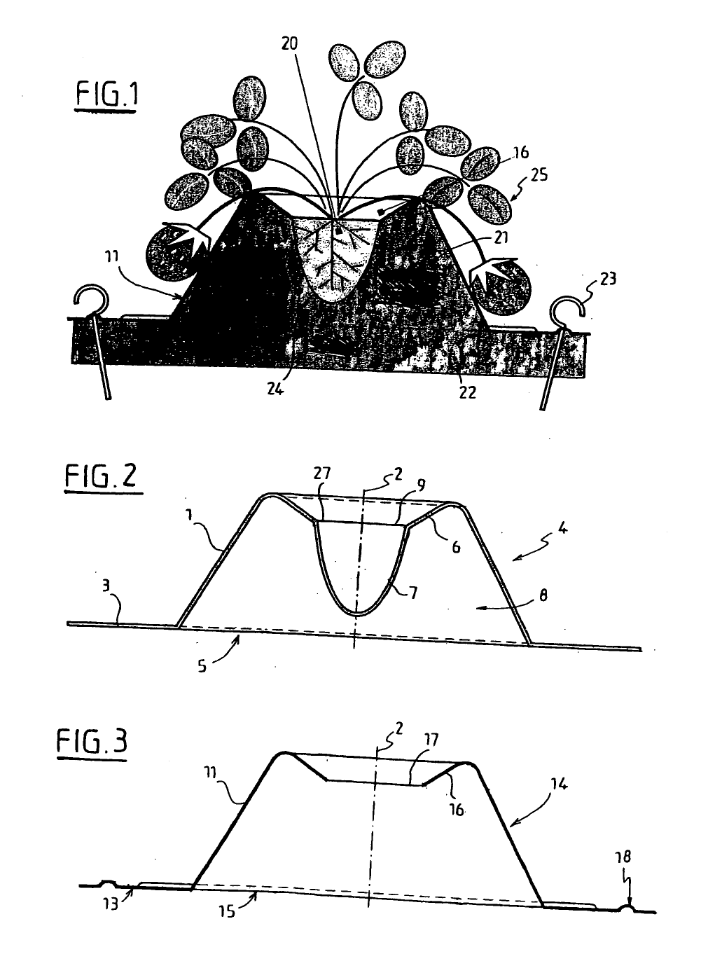

FIG. 1 depicts a view in section along a vertical plane of a mound of earth produced according to the method of the invention;

FIG. 2 depicts a view in section along a vertical plane of a mould according to the invention;

FIG. 3 depicts a view in section along a vertical plane of a mound cover according to the invention.

In the description the position references, top and bottom for example, will have effect with respect to the mound of earth, that is to say with respect to FIG. 1.

A mound and a recess are said to have complementary shapes in the case where the mound is of a size such that it fits in the recess produced at the top of the mound and adding earth around the mound is not necessary to effect the planting.

The invention proposes a method of producing a mound of earth on the ground comprising:
a step of filling a mould with earth;
a step of turning over the mould on the ground;
a step of at least partial removal of the mould;
   a method during which a recess is produced on the top of the mound by the mould during the moulding of the mound by the mould and characterised in that the step of turning over the mould is preceded by a step of placing a covering plate on the mould and followed by a step of removing the cover plate.

The cover plate (not shown) facilitates the turning over and manipulation of the mould 1. The cover plate is put in place against the opening 5, this plate coming into abutment against the panel 3. This cover plate enables the mould 1 and earth contained in the mould 1 to be turned over without the earth spilling during the turning over.

This turning-over plate is put in place before the turning-over step and removed after this step, pulling on it in order to make it slide under the mould 1.

FIG. 2 depicts a mould 1, adapted to producing a mound of earth 21.

This mould 1 consists of a truncated cone 4 that forms the lateral walls of the mould 1; a surface 7 preferably situated at the centre of the mould 1 and at its top and a connecting surface 6 forming the bottom of the mould 1 between the truncated cone 4 and the surface 7. The surface 7 extends from the connecting surface 6 towards the inside of the truncated cone 4.

The mould 1 comprising an opening 5 situated at the base of the truncated cone 4, this opening 5 allowing access to the filling area 8 situated inside the truncated cone 4. The mould 1 can also comprise a panel 5 integral with the base of the truncated cone 4 and leaving free access to the opening 5. This panel 3 can be rectangular in shape, which facilitates the positioning of several moulds alongside each other in the case where several mounds 21 are produced simultaneously. It also serves as a support surface when the mould 1 is turned over.

This mould 1 makes it possible to produce a mound of earth 21 rapidly. The mould 1 is filled with earth through the opening 5, is turned over on the ground 22 and is then removed, thus leaving space for a mound 21 of earth which has the shape of the mould 1 and in particular the mound 21 has, at its top, a recess 24 produced by the surface 7 when the mound 21 is moulded.

During the step of filling the mould 1 the earth can be replaced by special garden mould or a fertiliser depending on the plantlet that will subsequently be planted in the mound 21, in order to improve its development. This avoids having to treat all the ground or at the hump.

The mould will preferentially be produced from plastics material.

FIG. 3 depicts a mound cover 11 protecting the mound 21. This mound cover 11 comprises a truncated cone 14 that forms the lateral walls of the mound cover 11; a top surface 16 forms the top of the mound cover 11.

The mound cover 11 comprises an opening 15, situated at the base of the truncated cone 14; this opening enables the mound cover 11 to be placed on the mound 21.

The top surface 16 is provided with an opening 17 that allows access to the recess 24 in the mound 21. The mound cover 11 can also comprise a panel 13 integral with the base of the truncated cone 14 and leaving free access to the opening 15; this panel 13 can be rectangular in shape, which facilitates the positioning of several mound covers alongside one another where several mounds 21 are produced simultaneously.

The mound cover can also comprise piercings 18 that allow the introduction of stakes 23 for fixing in the ground 22 in order to hold it and prevent it blowing away under the effect of the wind.

The mound cover 11 has an overall external shape that corresponds to that of the mound 21 except with regard to the recess 14.

The mound cover will preferentially be produced from plastics material.

The mould 1 and the mound cover 11 are in the case in FIGS. 2 and 3 roughly of volumes of revolution about the axis 2.

The mould 1 serves to produce a mound of earth 21 that is then covered by the mound cover 11 (FIG. 1). The mound cover 11 makes it possible to keep the shape of the mound 21 and prevent its flattening because of bad weather; it also increases the heat in the mound 21 and prevents the fruit being dirtied by the earth.

As described previously, the mould 1 makes it possible to quickly produce a mound of earth 21 that has at its top a recess 24 produced by the surface 7.

During the step of removing the mould 1, the removal can be either total and then a step of placing a mound cover 11 is necessary, or partial and in this case a placing of a mound cover 11 is not necessary. This is because, in the case of partial removal, only the part corresponding to the surface 7 will be removed, recreating from the mould 1 the contours of the mound cover 11. The line 9 of intersection between the surface 7 and connecting surface 6 delimits the part corresponding to the surface 7 that will be removed. An opening 27 is thus created along the intersection line 9 allowing access to the recess 24.

After the production of the mound of earth 21, a plantlet and its clod 20 are planted in the recess 24 through the opening 17 in the mound cover 11 in the case of total removal of the mould 1 or through the opening 26 in the mould 1 in the case of partial removal of the mould 1.

The clod 20 and recess 24 have complementary shapes, in particular semi-ellipsoid, in order to facilitate the placing of the clod 20 in the recess 24.

The mound cover 11 makes it possible to create a clean surface, without earth, thus preventing contact between the plant 25, issuing from the plantlet, and the earth of the mound 21 or ground 22.

The top surface 16 has a slope descending from the truncated cone 14 towards the opening 17 in order to assist the flow of water towards the roots of the plantlet during watering or when it rains, thus assisting the development of the plant 25. The top surface 16 can be a truncated cone.

In a similar fashion, in order to keep compatibility between the mould 1 and the mound cover 21, the connecting surface 6 has a slope descending from the truncated cone 4 towards the surface 7, the connecting surface 6 then being able to be a truncated cone.

Naturally the present invention is not limited to the examples and embodiments described and depicted but is capable of many variants accessible to persons skilled in the art. In particular the overall shapes of the mould 1 and mound cover 11 and the truncated cones 4 and 14 can take all shapes, of revolution or not.

1. A method of producing a mound of earth (21) on the ground (22) comprising:
a step of filling a mould (1) with earth;
a step of placing a cover plate on the mould (1);
a step of turning over the mould (1) on the ground (22);
a step of removing the cover plate;
a method during which a recess (24) is produced at the top of the mound (21) by the mould (1) during the moulding of the mound (21) by the mould (1) and characterised in that it comprises a step of partial removal of the mould (1) so as to leave clear access to the recess (24).

2. A method of producing a mound of earth (21) on the ground (22) comprising:
a step of filling a mould (1) with earth;
a step of placing a cover plate on the mould (1);
a step of turning over the mould (1) on the ground (22);
a step of removing the cover plate;
a step of removing the mould (1);
a method during which a recess (24) is produced at the top of the mound (21) by the mould (1) during the moulding of the mound (21) by the mould (1) and characterised in that the step of removing the mould (1) is followed by a step of placing a protective mound cover (11) covering the mound (21).

3. The method of claim 1, characterised in that the recess (24) is a semi-ellipsoid.

4. A method of planting a plantlet and its clod (20), comprising:
a step of producing a mound (21) of earth according to one of claim 1;
a step of placing the plantlet and its clod (20) in the recess (24) in the mound (21) through an opening (17, 27) in the mound cover (11, 1);
characterised in that the clod (20) and the recess (24) have complementary shapes.

5. A mould (1) adapted to producing a mound (21) according to the method of one of claim 1, comprising:
a truncated cone (4) forming the lateral walls of the mould (1);
a surface (7) at the centre of the mould (1);
a connecting surface (6) forming the bottom of the mould (1) between the truncated cone (4) and the surface (7) extending from the connecting surface (6) towards the inside of the truncated cone (4) in order to produce the recess (24) at the top of the mound (21); and
a covering plate for the mould (1);
the mould (1) being characterised in that the surface is a semi-ellipsoid.

6. The mould (1) of claim 5, characterised in that the surface (7) is removable.

7. The mould (1) of claim 5, characterised in that the connecting surface (6) descends from the truncated cone (4) towards the surface (7).

8. The mould of claim 7, characterised in that the connecting surface (6) is a truncated cone.

9. The protective mound cover (11) for a mound (21) of earth produced according to the method of claim 1, comprising:
a truncated cone (14) forming the lateral walls of the mound cover (11);
a top surface (16) forming the top of the mound cover (11);
characterised in that the top surface (16) is provided with an opening (17) for access to the recess (24).

10. The mound cover (11) of claim 9, characterised in that the top surface (16) descends from the truncated cone (14) towards the opening (17).

11. The mound cover (11) of claim 10, characterised in that the top surface (16) is a truncated cone.
